(19) United States
(12) Patent Application Publication
(10) Pub. No.: US 2004/0077744 A1
(43) Pub. Date: Apr. 22, 2004

(54) Polymerisation process

(76) Inventors: Gareth Ian Naylor, West Yorkshire (GB); Lee Raistrick, West Yorkshire (GB); Philippa Jane James, West Yorkshire (GB); David Green, West Yorkshire (GB); Martin William Whitley, West Yorkshire (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/468,191

(22) PCT Filed: Feb. 5, 2002
(86) PCT No.: PCT/EP02/01161

(30) Foreign Application Priority Data
Feb. 20, 2001 (GB) 01041425
Jul. 27, 2001 (GB) 01183441

(51) Int. Cl. C08F 4/46

(52) U.S. Cl. 522/150; 522/151

(57) ABSTRACT

A process of preparing water soluble or water swellable polymer comprising the steps: a) forming an aqueous mixture comprising, i) a water soluble ethylenically unsaturated monomer or blend of monomers and, ii) at least one first ultra-violet initiator, iii) at least one second ultra-violet initiator; b) effecting polymerisation by subjecting the aqueous mixture formed in step (a) to irradiation by ultraviolet light at an intensity of up to 1,000 μWcm⁻²; subjecting the product of step (b) to irradiation by ultraviolet light of greater than 1,000 μWcm⁻², characterised in that a significant amount of the first initiator(s) is/are activated in step (b) and a significant amount of the second initiator(s) is/are activated in step (c). The process is particularly suitable for making highly effective water soluble and water swellable polymers useful as flocculants, coagulants, rheology modifiers, dispersants, superabsorbents and binders etc.

The present invention relates to a process for making water soluble or water swellable polymers, by polymerisation of water soluble ethylenically unsaturated monomer or monomer blend. In particular the invention relates to processes of making said polymers containing low concentrations of residual monomer.

Water soluble and water swellable polymers are used in numerous industrial applications, for instance, flocculants, coagulants, rheology modifiers, dispersants, superabsorbents and binders. Of particular importance are high molecular weight water soluble polymeric flocculants which may be used as retention or drainage aids in paper making or to flocculate sludges such as sewage sludge, waste waters, textile industry effluents red mud from the Bayer Alumina process and suspensions of coal tailings etc.

It is standard practice to prepare water soluble or water swellable polymers by polymerising water soluble monomers using a suitable initiator system. The polymers are usually provided either as a solid particulate product or as a reverse phase dispersion or emulsion. Typically particulate polymers are prepared introducing initiators into an aqueous solution of the monomers and polymerising to form a polymer gel which is then cut into smaller pieces, dried and then ground to the appropriate particle size. Alternatively the polymers are produced as beads by suspension polymerisation or as a water-in-oil emulsion or dispersion by water-in-oil emulsion polymerisation, for example according to a process defined by EP-A-150933, EP-A-102760 or EP-A-126528.

It is known to produce water soluble and water swellable polymers using a variety of initiator systems. For instance it is common practice to polymerise water soluble monomers using redox initiator couples, in which radicals are generated by admixing with the monomer a redox couple which is a reducing agent and an oxidising agent. It is also conventional practice to use either alone or in combination with other initiator systems a thermal initiator, which would include any suitable initiator compound that releases radicals at an elevated temperature. Other initiator systems include photo and radiation induced initiator systems, which require exposure to radiation to release radicals thereby effecting polymerisation. Other initiator systems are well known and well documented in the literature.

Although water soluble and water swellable polymers can be prepared using many of the commercially available initiator systems, it is often difficult to prepare on an industrial scale polymers which have the correct molecular weight in combination with other desired characteristics, such as solubility, degree of absorbency etc. Over the last ten to fifteen years it has also become increasingly important to provide polymers which have extremely low levels of residual free monomer. This is particularly the case for polymers based on acrylamide monomer.

There have been various proposals in the literature for reducing residual free monomer concentrations in polymers, especially polymers of acrylamide. For instance in U.S. Pat. No. 4,906,732 and U.S. Pat. No. 4,996,251 polyacrylamides are treated with an amidase enzyme which is active towards acrylamide. However, although it was possible to achieve very low levels of free acrylamide, the enzymes proposed in these patents cannot consistently especially at elevated temperatures.

WO-A-97 29136 describes an amidase enzyme which is particularly effective at high temperatures and thus can be applied to the hot polymer gel substantially immediately prior to the drying stage. However, although this enzyme has shown particular advantages over other known amidases, it is still nonetheless difficult to consistently achieve low residual levels of acrylamide on an industrial scale.

In PCT/EP 01/00429 (unpublished at the date of filing the present application) a process of preparing water soluble or water swellable polymer is described in which aqueous monomer mixture containing ultra violet light initiators is first polymerised in the absence of ultra violet light and then once polymerisation is complete the polymer is subjected to ultra violet light radiation at an intensity of up to 500 milli Watts. This process brings about significant benefits in providing the desired water soluble or water swellable polymer containing reduced residual unreacted monomer. However, there is still scope for improvements and a desire to provide a still more convenient process that reduces free monomer and at the same time reduces processing time, without impairing the quality of the polymer formed.

Therefore there exists a need to be able to conveniently and consistently provide water soluble or swellable polymers with no or extremely low levels of residual monomer, especially acrylamide monomer.

There also exists a need to achieve this in an industrial scale process and in particular in a process which does not require additional long residence stages in the production process. In particular there is a need to provide a convenient process which provides high molecular weight water soluble polymer, of consistent quality and high solubility, with no or substantially reduced levels of insoluble material and moreover contains substantially reduced levels of residual monomer.

The present invention provides a process of preparing water soluble or water swellable polymer comprising the steps,

(a) forming an aqueous mixture comprising,

(i) a water soluble ethylenically unsaturated monomer or blend of monomers and,

(ii) at least one first ultra-violet initiator,

(iii) at least one second ultra-violet initiator,

(b) effecting polymerisation by subjecting the aqueous mixture formed in step (a) to irradiation by ultraviolet light at an intensity of up to 1000 μWcm⁻²,

(c) subjecting the product of step (b) to irradiation by ultraviolet light of greater than 1000 μWcm⁻²,

characterised in that a significant amount of the first initiator(s) is/are activated in step (b) and a significant amount of the second initiator(s) is/are activated in step (c).

Sufficient of the first initiator(s) is/are activated to effect polymerisation in step (b). Generally the amount of first initiator(s) activated during step (b) will be at least 10%. Typically it will be much higher, for instance at least 30 or 40%, although usually by the end of step (b) at least 50% and up to 90 or 100% of the first initiator(s) are activated during step (b). In some cases it may be preferred that substantially all of the first initiator(s) is activated during step (b). In other instances it may be desirable for at least 50 or 60% up to 70 or 80% of the first initiator(s) to be activated in step (b). A significant amount of the second initiator(s) must be activated in step (c). Generally the amount of second initiator(s) activated in step (c) will be sufficient to reduce the level of free monomer present in the polymer. Typically the amount of second initiator activated in step (c) will be at least 10%. Although usually it will be much higher, for instance at least 30 or 40%, although usually this will be at least 50% and up to 90 or 100%. In some cases it may be desirably for all of the second initiator(s) to be activated in this second step. Nevertheless some activation of the second initiator may occur and may even be desirable during the step (b). Thus in some instances the amount of second initiator activated in step (c) may be at least 50 or 60% up to 70 or 80%. All percentages are by weight of initiator.

Preferably in the process according to the present invention the first initiator(s) is/are activated in step (b) and the second initiator(s) is/are predominantly activated in step (c). Typically at least 50% by weight of the second ultraviolet initiator remains unactivated in step (b).

The intensities are determined using Solatell Solascope spectroradiometer. This instrument provides light intensity and light wavelength information. The instrument is static when measuring and therefore provides intensity information at any one point under the UV light.

It is essential to the present process that there are two distinct steps (b) and (c), since if the radiation intensity is increased during the polymerisation step (b) to above 1000 μWcm⁻², we have found that this has a deleterious effect on the polymerisation and the polymer product that is formed. Thus it is necessary to have clearly separate polymerisation and post polymerisation post treatment steps. Thus step (b) and step (c) must be kept separate.

The advantage of being able to use relatively low levels of radiation intensity during polymerisation and moderately low levels of radiation intensity post polymerisation, especially for reduced period of treatment, is that there is a reduced risk of inducing denaturing of the polymer. One effect of denaturing the polymer may be undesirable or uncontrolled cross-linking or unacceptable loss of solubility. This may be particularly important when preparing high molecular weight water soluble polymers, where cross-linking and/or loss of solubility could have a deleterious effect on performance. To a certain extent exposure to high levels of ultra violet radiation may be detrimental to deliberately cross-linked polymers in that the additional cross-linking would be uncontrolled and could also lead to a loss of performance. Thus for a cross-linked superabsorbent polymer excessive exposure to ultra-violet cross-linking may result in excessive cross-linking which could impair the absorbency characteristics. Over exposure to ultra violet radiation can also lead to breakdown of the polymer to produce undesirable low molecular weight polymer molecules, which can have a deleterious effect on the performance of the polymeric product.

Desirably the ultraviolet light intensity in step (b) is between 100 μWcm⁻² and 1,000 μWcm⁻². Generally the intensity will be below 800 μWcm⁻² and suitable range may be for instance 100 to 400 or 500 μWcm⁻². In particular we find that improved results are obtained using an intensity of between 100 μWcm⁻² and 200 μWcm⁻². We have found that these ranges of ultra violet light intensities provide optimum polymerisation of the monomer. In addition the levels of intensity are insufficient to cause complete activation of the second initiator(s), even at prolonged periods of exposure during the polymerisation process. The polymerisation step is generally completed within 1 hour. Generally polymerisation is complete within much shorter periods of time for instance up to 30 minutes, for instance up to 20 minutes. In order to obtain polymers of sufficiently high molecular weight it is often necessary for the polymerisation phase to be at least 5 or 6 minutes. Preferably the polymerisation is between 10 and 20 minutes, in particular around 15 minutes.

Thus in the present invention the polymerisation process is initiated from the first ultra violet initiator. Nevertheless it is also possible that some radicals are generated from the second initiator but to a lesser extent, provided that sufficient of the second initiator remains capable of being activated during the post polymerisation treatment step. Usually substantially all of the first ultraviolet initiator(s) is/are activated in step (b).

In the following table an example of a typical light map obtained with the Solatell Solascope. As the Solatell measures specific points, the we quote the centre point measured. The values quoted are given in micro watts cm⁻².

| | | | | | | | | |
|---|---|---|---|---|---|---|---|---|
| 29 | 33 | | 39 | 36 | 37 | | 29 | 25 |
| 44 | 50 | 68 | 69 | 82 | 72 | 70 | 52 | 43 |
| 65 | 92 | 127 | 157 | 143 | 146 | 126 | 88 | 65 |
| 44 | 58 | 78 | 90 | 76 | 76 | 80 | 57 | 42 |
| 28 | 33 | | 40 | 39 | 39 | | 32 | 36 |

These intensities are additive and as a result lights can be arranged so as to give more even footprint. Thus in accordance with polymerisation step (b) of the present invention the lamps would be arranged to give a relatively uniform intensity. Thus in one preferred aspect the lights could be arranged so as to give an average of 100 microwatt cm². In this stage of the process the light would never exceed an average value 1000 microwatts cm⁻².

The intensity may be varied during the polymerisation step, provided that the intensity does not exceed 1000 microwatts cm⁻². However, preferably the polymerisation step (b) is conducted using ultra violet light which is substantially at one intensity. Thus the average intensity is preferably not substantially increased or decreased during the polymerisation step. Typically the average intensity will not vary by more than about 10%.

The polymerisation step be may be effected by a single irradiation treatment of substantially the same intensity. Alternatively more than one irradiation treatment may be used. Thus a multiplicity of irradiation treatments, preferably of substantially the same intensity may be applied. In some instances it may be desirable to use a pulsed treatment, wherein the radiation that is delivered is preferably of the same time average intensity. Thus when pulsed the intensity averaged over the whole period should desirably be up to 1000 μWcm⁻².

Alternatively the power to each individual light may be modified to provide a continuum of intensity. The profile of the continuum of intensity may be adjusted to provide products of a particular desired molecular weight. Preferably the profile would be set to provide a relatively lower intensity at the start of step (b) and increasing the intensity during the polymerisation step (b) to a maximum. The intensity of the light must not increase beyond 1000 μWcm² during step (b). In a further alternative form the intensity may be increased in stages rather than as a continuum. This technique of increasing the intensity in stages has been found to be particularly advantageous when producing anionic polymers.

It will normally be necessary to ensure that dissolved oxygen and dissolved gases are not present in the monomer. Thus nitrogen gas can be passed through the aqueous monomer medium in order to remove dissolved oxygen or other volatile reactive species, prior to polymerisation. The polymerisation step should normally be conducted in an inert atmosphere in order to prevent oxygen or oxidising species from adversely affecting the polymerisation. This may be achieved by conducting the polymerisation in an inert gaseous atmosphere, for instance under nitrogen gas.

Once the polymerisation is at least substantially complete the polymer formed is subjected to a higher intensity which is intended to activate the second initiator(s). Thus it is essential in the present invention that sufficient of the second initiators remain at least partially unactivated prior to commencing the post polymerisation step (c).

In the post polymerisation step (c) the polymer is treated with greater than 1,000 μWcm² in order to activate the initiator(s). Although the post polymerisation step requires much higher intensity irradiation, the period of irradiation is generally much shorter. Typically the ultra violet light intensity in step (c) is between 1 mWcm⁻² and 1,000 mWcm⁻², preferably the intensities are between and the duration of step (c) is no more than 10 minutes. Often the treatment step (c) is significantly less than 10 minutes, for instance no more that 5 minutes. Surprisingly we have found that in many instances the levels of free residual monomer can be reduced to insignificant levels with irradiation of 1 or 2 minutes and in some cases need only be for a matter of a few seconds, for instance less that 30 or 45 seconds. The treatment can be as low as 1 second, but is generally at least 5 seconds and more desirably is at least 10 or 15 seconds. Generally preferred results are obtained using a duration of treatment lasting from between 10 seconds and 5 minutes.

The intensity may be varied during the step (c) of the process provided that the radiation intensity is above 1000 microwatts cm⁻². However, preferably this post polymerisation step (c) is conducted using ultra violet light which is substantially at one intensity. Thus the average intensity is preferably not substantially increased or decreased during the polymerisation step. Typically the average intensity will not vary by more than about 10%.

The post polymerisation step be may be effected by a single irradiation treatment of substantially the same intensity. Alternatively more than one irradiation treatment may be used. Thus a multiplicity of irradiation treatments, preferably of substantially the same intensity may be applied. In some instances it may be desirable to use a pulsed treatment, wherein the radiation that is delivered is preferably of the same time average intensity.

Thus we provide a process in which the ultraviolet light in step (c) is a constant or intermittent dose and wherein the ultraviolet radiation is substantially the same intensity. Thus when pulsed the intensity averaged over the whole period should desirably be above 1000 μWcm⁻².

It may be desirable the to increase the intensity of ultraviolet light during step (c). Thus the ultraviolet light in step (c) can be increased from a lower intensity which is greater than 1000 μWcm⁻² to a higher intensity. This increase may be done in stages or as a continuum.

It may be desirable to conduct the post polymerisation step (c) in an inert atmosphere in order to prevent oxygen or oxidising species from adversely affecting the treatment. This may be achieved by conducting the polymerisation in an inert gaseous atmosphere, for instance under nitrogen gas.

Typically the common structural characteristics of conventional photoinitiators, may contain two possibly substituted phenyl nuclei, the aromatic systems of which are cross-conjugated via one or two carbon atoms. GB 1598593 describes hydroxyalkyl ketones having only one aromatic ring as photoinitiators or photosensitisers.

Compounds represented by formula (1) below are typical of hydroxyalkylphenone ultra violet initiators.

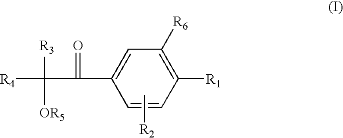

In formula (I), R₁ is can be alkyl or alkoxy of up to 18 carbon atoms, for instance 1 to 12 carbon atoms, a chlorine atom, dialkylamino of 2 to 4 carbon atoms or phenyl. Typically R₁ is often an alkyl group of up to 12 carbon atoms of the dimethylamino group. R₂ is often hydrogen and may be preferred in the 3-position. It can also be a chlorine or bromine atom or a methyl or methoxy group in the 2- or 3-position, of the phenyl nucleus.

For R₃ and R₄, generally not more than one is a hydrogen atom and usually these are compounds in which both residues R₃ and R₄ are alkyl groups which together contain 2 to 10, preferably 2 to 8 carbon atoms.

R₅ may be hydrogen. When it is alkyl or alkanoyl, of these methyl, ethyl and acetyl are often employed.

Finally, R₆ may be hydrogen and normally it is only a methyl group when R₁ is hydrogen and R₂ is 2-methyl.

The preparation of typical hydroalkylphenone based ultra violet initiators is referenced in GB 1598593 and also in Bull. Soc. Chim. France 1967,1047-1052; J. Amer. Chem. Soc. 75 (1953), 5975-5978; and Zh. Obshch. Khim. 34 (1964), 24-28. Typical compounds which are suitable as ultra violet initiators include, 1-phenyl-2-hydroxy-2,3-dimethyl-1-butanone, 1-phenyl-2-hydroxy-2,3,3-trimethyl-1-butanone, 1-phenyl-2-hydroxy-2-ethyl-3,3-dimethyl-1-butanone, 1-phenyl-2-hydroxy-2-methyl-1-hexanone, 1-phenyl-2-hydroxy-2-ethyl-1-hexanone, 1-phenyl-2-hydroxy-2-methyl-1-heptanone, 1-phenyl-2-hydroxy-2-ethyl-1 -heptanone, 1-phenyl-2-hydroxy-2-butyl-1-phenyl-2-hydroxy-2-ethyl-1-decanone, 1-benzoylcyclopropanol, 1-benzoylcyclopentanol, 1-benzoylcyclohexanol, 1-benzoylcycloheptanol, 1-(4′-chlorophenyl)-2-hydroxy-2-ethyl-1-hexanone, 1-(4′-methylphenyl)-2-hydroxy-2-ethyl1-hexanone, 1-(3′,4′-dimethylphenyl)-2-hydroxy-2-ethyl-1-hexanone, 1-(4′-i-propylphenyl)-2-hydroxy-2-ethyl-1-hexanone, 1-(4′-tert.-butylphenyl)-2-hydroxy-2-ethyl-1-hexanone, 1-(4′-hexylphenyl)-2-hydroxy-2-methyl-1-propanone, 1-(4′-octylphenyl)-2-hydroxy-2-methyl-1-propanone, 1-(4′-decylphenyl)-2-hydroxy-2-methyl-1-propanone, 1-(4′-dodecylphenyl)-2-hydroxy-2-methyl-1-propanone, 1-(4′-hexadecylphenyl)-2-hydroxy-2-methyl-1-propanone, 1-(4′-(2-ethylhexyl)-phenyl)-2-hydroxy-2-methyl-1-propanone, 4,4′-bis(2-hydroxy-2-methylpropanoyl)benzophenone, 4,4′-bis(2-hydroxy-2-ethylbutanoyl)-benzophenone, 4,4′-bis(1-hydroxycyclopentylcarbonyl)-benzophenone, 4,4′-bis(1-hydroxycyclohexylcarbonyl)benzophenone, 4,4′-bis(2-hydroxy-2-methylpropanoyl)diphenylmethane, 4,4′-bis(2-hydroxy-2-methylpropanoyl)-diphenyl oxide, or 4,4′-bis(2-hydroxy-2-methylpropanoyl)diphenyl sulfide.

Typical hydroxyalkyl phenone based initiators are compounds of formula:

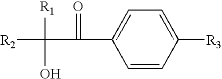

wherein R₁ and R₂ are each independently C₁₋₃ alkyl or together form a C₄₋₈ cycloaliphatic ring, R₃ is H, C₁₋₂ alkyl or —O(CH₂CH₂)ₙOH and n is 1-20.

Desirably the first and second ultra violet initiators are distributed homogenously throughout the aqueous monomer mixture, in order to achieve uniform initiation of the of polymerisation in step (b) and also uniform free monomer reduction during the post treatment stage of step (c). Preferably the ultra violet initiators are soluble or dispersible in the aqueous monomer or monomer blend.

It is essential to the present invention that the first ultra violet initiator is one or more initiators capable of being activated in step (b) of the process of the present invention and thus include compounds which generate sufficient radicals at intensities of up to 1,000 μWcm⁻² so that polymerisation can be effected.

Preferably the first ultra violet initiator is a hydroxyalkyl phenone, and more preferably is the compound of formula:

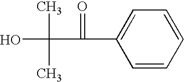

known as 1-phenyl-2-hydroxy-2-methyl-1-propane-1-one supplied as Darocur® 1173 photoinitiator by Ciba Specialty Chemicals.

Desirably the ultra violet initiator is used in an amount up to 10,000 ppm by weight of monomer. However, for economic reasons it is usually preferred not to use more than about 5,000. Suitable results are often obtained when the ultra violet initiator is included in an amount in the range 20 to 3,000 ppm, more preferably 50 to 2,000 ppm, especially 100 to 1,000 ppm.

The second ultra violet initiator may also be a hydroxyalkyl phenone, but is a compound which will not undergo any appreciable decomposition during the polymerisation process. Thus at least 50% by weight of the second ultraviolet initiator remains unactivated in step (b). Suitably the second initiator may be those of the above mentioned hydroxyalkyl phenones which are appreciably inactive at ultra violet light intensities of up to 1,000 μWcm⁻², but which are capable of generating sufficient radicals to carry out step (c) of the process at ultra violet light intensities of above 1,000 μWcm⁻², especially 1 mWcm⁻² to 1,000 mWcm⁻². Preferably the second initiator is the compound of formula:

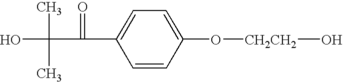

known as 1 -[4-(2-Hydroxyethoxy)-phenyl]-2-hydroxy-2-methyl-1-propane-1-one supplied as Irgacur® 2959 photoinitiator by Ciba Specialty Chemicals.

The amount of second initiator required is typically in the same range as the first initiator, for instance 20 to 3,000 ppm by weight of monomer. Typically the dose is less than 2,000 ppm often less than 1,000 ppm. Generally the most effective doses of initiator are at least 50 ppm but usually not more than 200 ppm.

The process of step (c) involves the procedure of subjecting the polymer that has been formed in the polymerisation step (b) to ultra violet radiation as described above. This may be done by passing the formed polymer under ultra violet lamps generating a light intensity of above 1,000 μWcm⁻², especially 1 mWcm⁻² to 1,000 mWcm⁻². For instance the polymer may be passed from the first stage and then irradiated with a suitable dose of ultra violet light and then passed to a drying section. Alternatively the polymer may be exposed to ultra violet radiation in the reactor vessel where the polymer has been made.

In some instances it may be possible for the first and second initiator to be the same, provided of course that the initiator is capable of achieving effective polymerisation in step (b) and for sufficient initiator to be present in the product of step (b) to enable step (c) to be effected. Suitably 1-phenyl-2-hydroxy-2-methyl-1-propane-1-one may be used as both the first and second initiators. Whist some polymers may be effectively prepared using the same initiator as both the first and second initiators, it is preferred that the first and second initiators are different compounds.

A further alternative form of the invention involves subjecting the polymer to ultraviolet light in the drying section. Thus in this form of the invention ultra violet lamps are mounted such that the polymer is exposed to ultra violet light whilst inside the drying equipment. For instance the drying equipment is a fluid bed dryer and the ultra violet lamps are mounted inside the dryer or alternatively outside the fluid bed drier. The lamps may desirably be positioned in any suitable orientation, for instance above, below or adjacent to the polymer product that is being treated.

It has been found that the process of the invention provides very effective a water soluble or water swellable polymer in which the amount of residual monomer is below 100 ppm.

The water soluble or water swellable polymer is prepared by polymerisation of a water soluble monomer or water soluble monomer blend. By water soluble we mean that the water soluble monomer or water soluble monomer blend has a solubility in water of at least 5 g in 100 ml of water, measured at 25° C.

The water soluble or water swellable polymer prepared according to the process of the present invention may be cationic, anionic, nonionic or amphoteric. It may be substantially linear or alternatively branched or cross-linked. Cross-linked or branched polymers are prepared by incorporating a branching or cross-linking agent into the monomer blend. The cross-linking or branching agent may be for instance a di- or multifunctional material that reacts with functional groups pendant on the polymer chain, for instance multivalent metal ions or amine compounds which can react with pendant carboxylic groups. Preferably, however, the cross-linking or branching agent will be a polyethylenically unsaturated compound, which becomes polymerised into two or more polymer chains. Typically such cross-linking agents include methylene-bis-acrylamide, tetra allyl ammonium chloride, tri-allyl amine and polyethylene glycol di acrylate. The polymers may be highly crosslinked and therefore water insoluble but water swellable. Alternatively the polymer may be water soluble and either substantially linear or slightly branched, for instance prepared using less than 10 ppm cross-linking/branching monomer.

It may also be useful to include chain transfer agents to regulate the molecular weight of the polymer. Typically chain transfer agents include sodium hypophosphite, isopropanol and mercapto compounds such as 2-mercapto ethanol. The chain transfer agents may be included in high concentrations, such as 5 or 10% by weight of monomer. Generally the levels of chain transfer agent where included are above 1 or 2 ppm by weight of monomer. Suitable levels of chain transfer agent may be relatively low for instance 10, 20 or 30 ppm up to for instance 50, 70 or 100 ppm. It may be desirable to use relatively moderate levels of chain transfer agent, for instance over 100 ppm to 5,000 ppm, for instance 200 or 300 ppm to 2,000 or 3,000 ppm. The chain transfer agents may be used alone or alternatively may be used in conjunction with branching agents or cross-linking agents, as defined above.

The water soluble or water swellable polymer may be cationic, anionic, amphoteric or non-ionic. Anionic polymers may be formed from one or more ethylenically unsaturated anionic monomers or a blend of one or more anionic monomers with for instance a nonionic monomer, preferably acrylamide. The anionic monomers include acrylic acid, methacrylic acid, maleic acid, crotonic acid, itaconic acid, vinylsulphonic acid, allyl sulphonic acid, 2-acrylamido-2-methylpropane sulphonic acid and salts thereof. A preferred anionic polymer is the copolymer of sodium or ammonium acrylate with acrylamide.

Cationic polymers may be formed from one or more ethylenically unsaturated cationic monomers optionally with for instance a nonionic monomer, preferably acrylamide. The cationic monomers include dialkylamino alkyl (meth) acrylates, dialkylamino alkyl (meth) acrylamides, including acid addition and quaternary ammonium salts thereof, diallyl dimethyl ammonium chloride. Preferred cationic monomers include the methyl chloride quaternary ammonium salts of dimethylamino ethyl acrylate and dimethyl aminoethyl methacrylate.

Amphoteric polymers include at least one cationic monomer (for example as defined above) and at least one anionic monomer (for example as defined above) optionally with a nonionic monomer, especially acrylamide.

Non-ionic polymers include polymers of any suitable non-ionic monomers, for instance, acrylamide, methacrylamide, N-vinylpyrrolidone and 2-hydroxyethyl acrylate. Preferred non-ionic polymers comprise acrylamide especially acrylamide homopolymers.

Preferably, the water soluble or water swellable polymers comprise acrylamide.

The polymer produced by the process of the present invention may be a relatively low molecular weight polymer, for instance polymerised to a molecular weight below 100,000, for instance 2,000 to 10,000. Preferably however, the polymers are relatively higher molecular weight, for instance at least 100,000, especially at least 500,000. Typically the polymer has a molecular weight in the range of above 1 million to 20 or 30 million or higher. In general these high molecular weight polymers tend to exhibit high intrinsic viscosities (IV), for instance at least 3 dl/g (measured at various polymer concentrations using standard techniques in 1 N NaCI buffered to pH 7.5 at 25° C.). Preferably the polymer has an IV of at least 4 dl/g often at least 7 or 8 dl/g, for instance at least 12 dl/g. In some cases it may be highly desirable for the polymer to have an IV as high as 20 or 30 dl/g or even higher. However especially preferred polymers have an IV in the range 8 to 18 dl/g.

Typically an aqueous solution of water soluble monomer may be polymerised by solution polymerisation to provide an aqueous gel or by reverse phase polymerisation in which an aqueous solution of monomer is suspended in a water immiscible liquid and polymerised to form polymeric beads or alternatively by emulsifying aqueous monomer into an organic liquid and then effecting emulsion polymerisation. Examples of reverse phase polymerisation are given in EP-A-150933, EP-A-102760 or EP-A-126528. Preferably the polymer is prepared by solution polymerisation.

The process of the present invention may also be used in a suspension polymerisation process, for instance as described in WO 98/30598, in which beads of narrow particle size are made from water-soluble monomer or monomer blend by reverse phase bead polymerisation by extruding aqueous monomer beads into or onto the top of an upflowing column of non-aqueous liquid and the beads polymerise as they float downwardly through the column during a period of at least 30 seconds. The resultant beads can have a very narrow particle size distribution.

According to a further aspect of the invention we provide a method of reducing the residual monomer content in a water soluble or water swellable polymer by subjecting the polymer to ultra violet irradiation in the presence of an ultra violet initiator. The ultra violet initiator may be applied to the surface of the formed polymer and allowed to coat the surface of the polymer particles and then subjecting the polymer to ultra violet radiation. In this aspect of the invention the ultra violet initiator would actually be absorbed into the polymer and is then preferably distributed throughout the polymer before being subjected to irradiation by ultra violet light. Alternatively the water soluble or water swellable polymer may be formed containing the ultra violet initiator distributed throughout the polymer. This may be for instance as a result of carrying out a process in accordance with the first aspect of the invention.

Preferably the method of reducing residual monomer is applied to polymers of acrylamide and said acrylamide polymer contains residual acrylamide monomer. More preferably the polymer of acrylamide is a relatively high molecular weight polymer and has an intrinsic viscosity of at least 4 dl/g, often at least 7 or 8 dl/g, for instance at least 12 dl/g. In some cases it may be highly desirable for the polymer of acrylamide to have an IV as high as 20 or 30 dl/g or even higher. Especially preferred are polymers of acrylamides which have an IV in the range 8 to 18 dl/g.

The process is particularly suitable for the production of various polymers of ethylenically unsaturated water-soluble monomers. Typically the polymers may be anionic, non-ionic or cationic. Ionic polymers of various anionic or cationic monomer contents can be made. Generally the polymers will be of up to 50% solids content.

A preferred form of the invention is directed to a continuous process. In this aspect of the invention the aqueous mixture formed in step (a) is subjected to step (b) and then step (c) while said aqueous mixture is on a moving carrier. Typically the moving surface can be a belt, a trough or some other suitable surface into which the monomer mixture is transferred and the moving surface conveys the monomer to a polymerisation zone where the monomer is irradiated in step (b) and then onto step (c). Thus we provide a process where polymer is produced continuously and the moving surface is a moving belt, which carries the aqueous mixture to step (b) where one or more ultraviolet lamps irradiates the mixture to form a polymer product and then carries the product of step (b) to step (c) where one or more ultraviolet lamps irradiates the mixture.

The moving belt preferably contains side members which enable sufficient monomer to be contained to a sufficient depth required for a commercially viable process. The belt should be water impermeable to enable the aqueous liquid monomer to be contained. The belt should desirably be constructed of a flexible but durable material. The belt may be constructed of any number of suitable materials, for instance, rubber, silicone, metallic or synthetic resin etc. A desirable belt material may be constructed of a silicone type material. The moving carrier may be for instance a single intact belt or some other suitable construction. An alternative moving carrier may be compartmentalised. The compartments may be of any suitable size. For instance each compartment may be from 0.6 metres by 0.3 metres to as much as 6 metres by 3 metres or larger if desired.

The aqueous monomer should fill the moving carrier to a suitable depth, for instance up to 60 mm, especially up to 30 or 40 mm. Generally though it is preferred that the depth is no more than 10 or 20 mm, for instance 2 mm to 8 mm. A particularly preferred depth is around 5 mm.

The moving carrier used in the polymerisation step (b) may be any suitable size normally used for a continuous polymerisation on a moving carrier. Typically the moving carrier may move at a speed of 0.1 to 1 or 2 metres per minute according to the particular requirements for polymerisation. Preferably the moving carrier is a conveyor belt and can be as much as 6 metres wide or wider, for instance 3 metres wide. The length can be any suitable length according to the production capacity required. For instance the conveyor may be as long as 400 or 500 metres in length. In some instances it may be relatively short, for instance between 2 and 10 metres.

The lamps may be arranged in a suitable manner in order to provide conditions commensurate with the requirements of the process. One suitable arrangement of lamps is for instance 10× Actinic /09 40 watt UV lamps positioned at 40 cm distance apart. This distance will however be adjustable. The distance from the point of irradiation may be adjustable, for example from 0.9 metres to 1.2 metres.

Another preferred aspect of the present invention relates to irradiating the monomer in step (b) using a substantially uniform distribution of intensity. We have found that this contributes significantly to the consistency of the polymer that is formed, since it reduces the risk of over irradiating some sections of monomer and under irradiating other sections. Such uniform distribution of ultra violet light reduces the risk of producing severely denatured polymer and only partially polymerised material containing high levels of unreacted monomer. Preferably the ultraviolet radiation in step (b) is substantially all in the range 100 to 200 μWcm⁻².

Generally any suitable ultra violet light source that generates the appropriate light intensity may be used. Various types of lamps may be used to achieve the desired radiation treatment. For instance a Nordson UV lamp with Aquacure quartz cooling tubes, a MAC 10 lamp with pyrex dichroic reflectors. Preferably a relatively low wattage lamp is preferred, for instance a Philips Actinic 09 40W lamp may be used to generate the ultra violet light of intensity up to 1,000 μWcm⁻². A Fusion F600 lamp with a D bulb 6 KW may be used to generate UV light with an intensity of greater than 1,000 μWcm⁻².

Generally the polymerisation step (b) may use an initial intensity with Philips actinic/09 40 Waft UV lights (wavelengths UVA—315 nm to 400 nm, UVB—280 nm to 315 nm). Once the polymerisation step is substantially complete step (c) the post polymerisation step commences with a second intensity. This can desirably be using either Fusion F600 microwave powered UV lamp (D-type bulbs) or Nordson Aquacure arc lamps may be used. The Fusion F600 lamp is generally concentrated in UVA and UVB but including UVC—100 nm to 280 nm. Desirably a glass sheet may be used to filter out any UVC. Alternatively Nordson Aquacure arc lamps may be used and have the advantage that they reduce the infra red radiation if desired.

The table below illustrates the map of light intensity under a Fusion light. (measurements with the Solatell). The units are milliWattscm⁻². Again the Solatell centre measurement is used. In the case of the Fusion lamp this is 1000 milli Watts cm⁻².

| | | | | |
|---|---|---|---|---|
| 5.34 | 10.61 | 30.5 | 6.84 | 4.55 |
| 4.42 | 54.25 | 798.91 | 8.35 | 2.21 |
| 4.68 | 43.14 | 1000 | 15.8 | 3.3 |
| 4.21 | 8.24 | 239.03 | 13.4 | 2.8 |
| 8.41 | 4.84 | 20.13 | 6.83 | 3.29 |

Therefore, although the whole of this footprint is utilised within the meaning of the present invention the intensity is quoted as being 1000 microwatts cm⁻².

The Fusion lamps can alternatively be referred to in terms of lamp output. The lamp power is 6 kw with a 10 inch bulb. This equates to 600 watts per inch/240 watts per cm. One third of this power is approximated to be infra red radiation, one third is electrical power so one third is UV component. This equates to 80 watts per cm

Generally the ultra violet lamps generate a higher intensity light in the centre of the light beam than at the outer section of the light beam. Unless there is compensation for this it is possible that some monomer is over irradiated and other monomer is not sufficiently irradiated.

We have found that the process can be operated in which a uniform distribution of intensity can be employed in which the ultraviolet radiation in step (b) and/or step (c) is provided by a multiplicity of individual ultra violet light sources, wherein each individual light source produces a light distribution pattern ranging from high intensity light in the centre to low intensity light at the out edges of the pattern, and arranging the light sources such that the light distribution patterns overlap in such a way that provides a substantially uniform distribution of light.

Step (b) and (c) may be conducted using one belt, wherein the monomer is applied to the belt and irradiated in accordance with step (b) of the process in order to effect polymerisation and then once polymerisation has substantially completed, the polymer may be irradiated in accordance with step (c). Alternatively upon polymerisation in phase one, the polymer will drop from a first belt onto a second belt.

Where a separate movable carrier is used for step (c) of the process, the conveyor will travel at any suitable speed, for instance 0.2 to 3 metres per minute. The conveyor may conveniently be up to 200 metres in length but can be as short as 0.5 metres in length. In this stage the polymer will be irradiated by any suitable arrangement of lamps that provide the required intensity. One suitable arrangement will be 2× Fusion lamps utilising a light footprint of 0.6 metres each. Alternative Nordson Aquacure lamps may also be suitable. Generally these lamps will be adjustable to a height of 500 mm.

This belt may be constructed from any suitable material, for instance the same material as the first belt. The belt in this section is preferably made from meshed PTFE coated Kevlar. In an alternative form of the invention the polymer may be irradiated from both above and below the belt. Thus a mesh belt allows for double sided irradiation of the gel in step (c) and as a result 2× Fusion lamps or 2× Nordson lamps will also be positioned on the under side of the step (c) belt. Lamp height to be adjustable up to 500 mm

The polymer formed by the process of the invention may be processed in a standard way. When the polymer has been made in accordance with a continuous process using one or two belts as described herein, the polymer generally needs one gel processing step to reduce the particle size to say 5 mm gel chip, which after standard drying can be further ground into a powder. The polymer gel may suitably be processed using a Leesona wherein the polymer gel is comminuted to form a gel chip of suitable size.

A typical arrangement the light sources is shown in

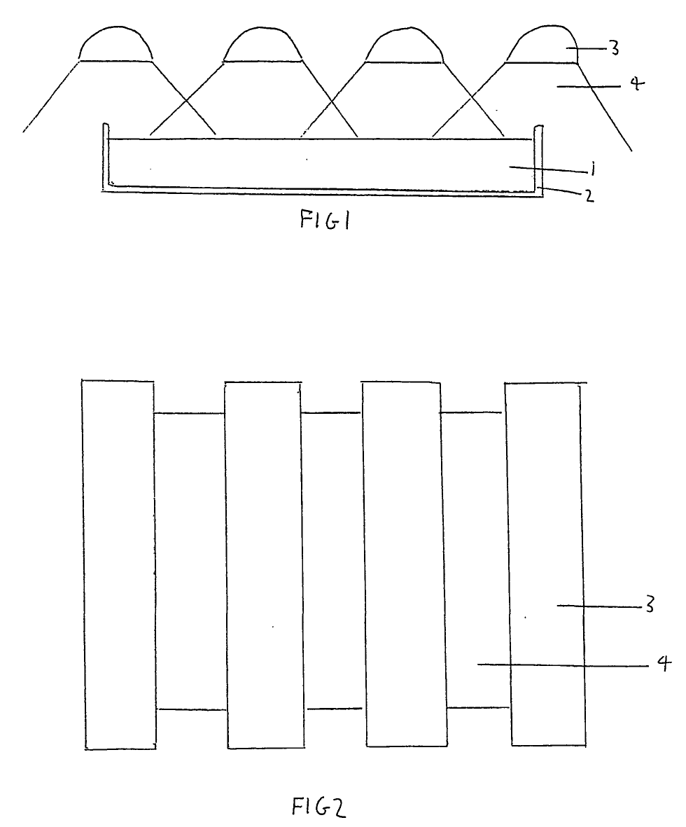

FIG. 1, in which [1] represents the aqueous monomer, [2] represent the container for aqueous monomer, [3] represents the ultra violet light source and [4] represents the ultra violet light beam.

FIG. 2 illustrates the arrangement of light sources in plan orientation.

In view of the combination effect of the overlapping light beams, the monomer is exposed to an effectively uniform distribution of intensity light.

It may also be desirable to filter the light to remove extraneous infra red light which is generally also produced by the ultra violet light source. In some cases it may be desirable to remove all of the infra red, but in other circumstances it may only be necessary only to remove a proportion of the infra red, where this may provide beneficial results.

We have also found that it may be desirable to filter the ultraviolet light through glass in order to remove undesirable electromagnetic radiation.

The process of the present invention enables polymers of high quality and preferably. Typically high molecular weight water soluble polymers, for instance of acrylamide and optionally other monomers, may be produced by this technique.

Such polymers may for instance be used as flocculants for use in industrial processes employing the separation of solids from suspensions. This includes the treatments of sludges and other waste suspensions. However, due to the ability to prepare polymers with low residual monomer content, the polymeric flocculants may be used in flocculation processes which require products which contain especially low levels of free monomer, for instance in food processing techniques.

Another important aspect of the process of the present invention is the ability to prepare electrophoretic gels. Such polymer gels are for instance used in electrophoretic separation of molecules based on the difference in charge density of the different molecules as well as a sieving effect of the porous gel media. Gel electrophoresis is today a widely used technique for separating bomolecules. The method is routinely used for separating proteins, peptides, nucleic acids etc. often with automated equipment based on fluorescence detection. One important application is separation of nucleic acid fragments for instance obtained in DNA sequencing.

Typically electrophoretic gels are composed of networks of cross-linked polymer molecules which form the pores of the gel. The separation qualities of such gel depends on, among other things, how big and how evenly distributed the pores of the network are. The size and the distribution on the other hand, are dependant on the dry solids content of the gel, on the cross-linker content and on the method of initiation.

The process of the present invention may be used to make such electrophoretic gels, for instance based on polyacrylamide. We have found that we can prepare polymer gels of high quality and reproducibility suitable for use as electrophoretic gels.

The following examples illustrate the invention, but are not intended to in any way limit the scope of the invention.

### EXAMPLE

1 Kg of aqueous monomer mixture was prepared comprising 80% by weight acrylamide and 20% by weight dimethylaminoethyl acrylate methyl chloride quaternary ammonium salt and having a total monomer concentration of about 30%. 500 ppm of 1-[4-(2-Hydroxyethoxy)-phenyl]-2-hydroxy-2-methyl-1-propane-1-one (Irgacure® 2959) and 500 ppm 1-phenyl-2-hydroxy-2-methyl-1-propane-1-one supplied as Darocur® 1173 photoinitiator were added in the monomer mixture. Nitrogen gas was passed through the aqueous medium in order to remove dissolved oxygen or other volatile reactive species.

The aqueous mixture was cooled to less than 10° C. and poured into a tray to a depth of 100 mm and subjected to ultra violet radiation using a Phillips Actinic 09 lamp (40 W) UV light source generating a uniform light intensity of 150 μWcm⁻² using the arrangement indicated in FIGS. 1 and 2. The irradiation was maintained for 20 minutes to produce a stiff hydrated polymer gel. The polymer gel was then irradiated using a Fusion F600 with a D bulb 6 KW generating an intensity between 1,000 mWcm⁻² at the centre of the beam and between 5 and 10 mWcm⁻² at the outer edges of the beam. The polymer was chopped and dried to form a dry powder. The intensities were determined using a Solatell Solascope as described herein.

The polymer was found to have an intrinsic viscosity of 16 dl/g and show high solubility, with a residual acrylamide content of below 100 ppm.

1. A process of preparing water soluble or water swellable polymer comprising the steps,
(a) forming an aqueous mixture comprising,
(i) a water soluble ethylenically unsaturated monomer or blend of monomers and,
(ii) at least one first ultra-violet initiator,
(iii) at least one second ultra-violet initiator,
(b) effecting polymerisation by subjecting the aqueous mixture formed in step (a) to irradiation by ultraviolet light at an intensity of up to 1,000 μWcm⁻²,
(c) subjecting the product of step (b) to irradiation by ultraviolet light of greater than 1,000 μWcm⁻²,
characterised in that a significant amount of the first initiator(s) is/are activated in step (b) and a significant amount of the second initiator(s) is/are activated in step (c).

2. A process according to claim 1 in which the first initiator(s) is/are activated in step (b) and the second initiator(s) is/are predominantly activated in step (c).

3. A process according to claim 1 or claim 2 in which the ultraviolet light intensity in step (b) is between 100 μWcm⁻² and 500 μWcm⁻².

4. A process according to any of claims 1 to 3 in which the ultraviolet light in step (b) is a constant or intermittent dose and wherein the ultraviolet radiation is substantially the same time average intensity.

5. A process according to any of claims 1 to 3 in which the ultraviolet light in step (b) is increased from a lower intensity to a higher intensity up to 1 000 μWcm⁻².

6. A process according to any one of claims 1 to 5 in which the ultra violet light intensity in step (c) is between 1 mWcm⁻² and 1,000 mWcm⁻², and the duration of step (c) is no more than 10 minutes.

7. A process according to any one of claims 1 to 6 in which the ultraviolet light in step (c) is a constant or intermittent dose and wherein the ultraviolet radiation is substantially the same time average intensity.

8. A process according to any of claims 1 to 6 in which the ultraviolet light in step (c) is increased from a lower intensity which is greater than 1000 μWcm⁻² to a higher intensity.

9. A process according to any one of claims 1 to 8 in which substantially all of the first ultraviolet initiator(s) is/are activated in step (b).

10. A process according to any of claims 1 to 9 in which the ultra violet initiator is a compound of formula:

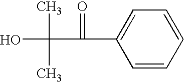

11. A process according to any one of claims 1 to 10 in which at least 50% by weight of the second ultraviolet initiator remains unactivated in step (b).

12. A process according to any one of claims 1 to 11 in which the ultra violet initiator is a compound of formula:

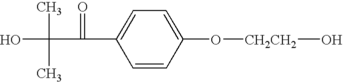

13. A process according to any one of claims 1 to 12 in which the aqueous mixture formed in step (a) comprises acrylamide.

14. A process according to any of claims 1 to 13 in which the polymer is a water soluble polymer which has an intrinsic viscosity of at least 4 dl/g.

15. A process according to any of claims 1 to 14 in which the aqueous mixture formed in step (a) is subjected to step (b) and then step (c) while said aqueous mixture is on a moving surface.

16. A process according to any one of claim 15 in which polymer is produced continuously and said moving surface is a moving belt, which carries the aqueous mixture to step (b) where one or more ultraviolet lamps irradiates the mixture to form a polymer product and then carries the product of step (b) to step (c) where one or more ultraviolet lamps irradiates the mixture.

17. A process according to any one of claims 1 to 16 in which the ultra-violet radiation in step (b) has a substantially uniform distribution of intensity.

18. A process according to any one of claims 1 to 17 in which the ultraviolet radiation in step (b) is substantially all in the range 100 to 200 μWcm⁻².

19. A process according to any one of claims 1 to 18 in which the ultraviolet radiation in step (b) and/or step (c) is provided by a multiplicity of individual ultra violet light sources, wherein each individual light source produces a light distribution pattern ranging from high intensity light in the centre to low intensity light at the out edges of the pattern, and arranging the light sources such that the light distribution patterns overlap in such a way that provides a substantially uniform distribution of light.

20. A process according to any one of claims 1 to 19 in which the ultraviolet light of step (b) and/or step (c) is filtered to remove at least some extraneous infra red radiation.

21. A water soluble or water swellable polymer obtainable by a process defined by any one of claims 1 to 20 in which the amount of residual monomer is below 100 ppm.
